(19) United States
(12) Patent Application Publication
(10) Pub. No.: US 2006/0192852 A1
(43) Pub. Date: Aug. 31, 2006

(54) System, method, software arrangement and computer-accessible medium for providing audio and/or visual information

(76) Inventors: Sally Rosenthal, Palo Alto, CA (US); Christoph Bregler, New York, NY (US); Clothilde Castiglia, Brooklyn, NY (US); Jessica De Vincenzo, Staten Island, NY (US); Roger Luke Dubois, New York, NY (US); Kevin Feeley, Manhaitan Beach, CA (US); Tom Igoe, Brooklyn, NY (US); Jonathan Meyer, New York, NY (US); Michael Naimark, Los Angeles, CA (US); Alexandru Postelnicu, Stamford, CT (US); Michael Rabinovich, Troy, NY (US); Katie Salen, Brooklyn, NY (US); Jeremi Sudol, New York, NY (US); Bo Wright, New York, NY (US)

Correspondence Address: DORSEY & WHITNEY LLP;INTELLECTUAL PROPERTY DEPARTMENT, 250 PARK AVENUE, NEW YORK, NY, 10177, US

(21) Appl. No.: 11/351,687

(22) Filed: Feb. 9, 2006

Related U.S. Application Data
(60) Provisional application No. 60/651,166, filed on Feb. 9, 2005.

(51) Int. Cl. H04N 7/18; H04N 9/47

(52) U.S. Cl. 348/61

(57) ABSTRACT

A system, method, software arrangement and computer-accessible medium are provided for tracking moveable objects, such as large balls, that a group of participants can interact with. For example, the motion of the objects may be used to control or influence the motion of certain virtual objects generated in a virtual environment, which may interact with other virtual objects. The virtual objects and their interactions may be used to generate video information, which can be displayed to the participants and which may indicate the occurrence of certain game-related events. Audio information may also be generated based on the interactions, and used to produce sounds separately from or in conjunction with the virtual objects.

### CROSS-REFERENCE TO RELATED APPLICATION(S)

This application claims priority from U.S. patent application Ser. No. 60/651,166, filed Feb. 9, 2005, the entire disclosure of which is incorporated herein by reference.

### GOVERNMENTAL SUPPORT

The research leading to the present invention was supported, at least in part, by the National Science Foundation under Grant numbers 0329098 and 0325715. Thus, the U.S. government may have certain rights in the invention.

### FIELD OF THE INVENTION

The present invention relates generally to motion capture, computer graphics, virtual environments and electronic image processing, and more specifically to a system, method, software arrangement and computer-accessible medium for providing audio and/or visual information where a group of people may simultaneously interface with one or more physical and/or virtual objects in three dimensions.

### BACKGROUND INFORMATION

Many types of devices exist that allow people to interact and interface with computers. Such devices include keyboards, computer mice, stylii, trackpads, trackballs, microphones, light pens, video game console controllers, and the like. Such devices may be wired to the computer or processing apparatus, and/or they may communicate wirelessly. Examples of wireless device communication can include infrared and radio frequency transmitters. Such wireless communication may also include a direct line of sight with a receiving sensor, such as with infrared communications, or they may only be able to communicate over a very limited range of distances.

Another type of interaction between people and computers can involve the use of motion capture devices. Motion capture technology generally relates to an ability to detect a location of one or more physical target objects by one or more sensors over a period of time, and providing information regarding the target objects. Examples of the motion capture technology include motion-capture suits including a plurality of sensors attached to a wearable garment. A motion of a person wearing such a suit may be converted into digital data, for example, to provide computer animators with lifelike models of motion. The motion capture technology can also allow a user to interact with a virtual environment, whereby the motion detected by the sensors may be converted to corresponding or proportional motion of a simulated object in a graphical display or environment. The sensors attached to these motion-capture suits may be wired, as a more complete freedom of movement may not be needed for capturing details or modest ranges of the motion.

Conventional computer interfaces may be operable by a single person at one time, such as computer mice or keyboards. Furthermore, certain devices may be configured to allow a plurality of people to interface with a single computer or graphical environment. Such a device can be a multiplayer video game, where a plurality of controllers can allow more than one player to simultaneously control objects on a display screen. This type of multiplayer interaction can be considered an extension of the types of single-person interface devices described above. Such devices may offer only a limited range of physical movement when interfacing with a computer.

One example of a multi-person computer interface with a limited range of motion is described in U.S. Pat. Nos. 5,210,604 and 5,365,266. The system described therein can provide each of a plurality of users a reflective paddle including green reflective tape on one side, and red reflective tape on the other side. The users can hold either the red side or the green side of their respective paddles towards the cameras to provide a group input to a computer system. One or more cameras directed at the group of users can detect the color reflected by the paddles from lights mounted close to the cameras. The reflected colors can be suitably averaged spatially to obtain relative intensities of the two colors (i.e., red or green). The input provided by the users' choice of colors can then be used, for example, to provide a group ‘voting’ function, where each user may select one of two options by holding the corresponding colored side of their respective paddles towards the camera. This system can then be used to aggregate the ‘votes’ based on the relative color intensities detected thereby.

### OBJECTS AND SUMMARY OF EXEMPLARY EMBODIMENTS OF THE INVENTION

Certain exemplary embodiments of the present invention provide a system, method, software arrangement and computer-accessible medium for monitoring or tracking the state of moveable objects along with changes in the state of these objects relating to interactions with a plurality of participants. One or more sensors may be provided that can be configured to communicate with one or more processors to perform the monitoring or tracking. Data describing the state of an object may include, for example, the position, velocity or altitude of the object. State data may also include whether the object is in an active state, an inactive state, a present state, an absent state, an intact state, a damaged state, a complete state and/or an incomplete state. The state data may also identify whether an object is requesting assistance, located at or away from a goal position, at a predetermined position relative to another object, or at a relative position with respect to a defined boundary or location. The state data may be obtained in real time.

In certain exemplary embodiments of the present invention, game-related events can be obtained from the monitoring data and provided to applications which may include entertainment experiences. For example, certain exemplary embodiments of the present invention may be directed to a method or system for a game where the monitored objects are balls and the sensors are cameras, and where the location and/or velocity of the balls may be used as data input to an entertainment software program. One or more processors configured to execute the program may generate or modify audio and/or video information based at least in part on the received data.

In further exemplary embodiments of the present invention, the moveable objects may be balloons, balls, flying discs, etc.

In other exemplary embodiments of the present invention, the system, method, software arrangement and/or computer-accessible medium may provide a plurality of virtual objects within a virtual environment and facilitate interactions within the virtual environment. The motion or characteristics of one or more virtual objects may be correlated with, influenced by, or controlled by state data associated with one or more physical objects. Interactions among virtual objects may also be detected or calculated, and such interactions can be used to control audio or video information. Video information, which can include information describing the virtual environment, may be displayed on one or more display devices such as television monitors or projection screens, and audio information may be used to produce sounds from one or more speakers, transducers, etc. State data may also be used to control the characteristics of one or more lights such as spotlights, where the characteristics may include intensity, direction, color, and/or whether the light is on or off.

In further exemplary embodiments of the present invention, game-related events may be defined at least in part by state data associated with real and/or virtual objects. Occurrence of such events may be used to trigger or increment game-related parameters such as points scored, time elapsed, game levels, etc.

These and other objects, features and advantages of the present invention will become apparent upon reading the following detailed description of embodiments of the invention, when taken in conjunction with the appended claims.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 is a system block diagram of an exemplary embodiment of a system according to the present invention;

FIG. 2 is a system block diagram of a second exemplary embodiment of a system according to the present invention;

FIG. 3 is a flow diagram of an exemplary embodiment of a method according to the present invention;

FIG. 4 is a system block diagram of a third exemplary embodiment of a system according to the present invention; and

FIG. 5 is a system block diagram of a fourth exemplary embodiment of a system according to the present invention.

FIG. 6 is a system block diagram of a fifth exemplary embodiment of a system according to the present invention.

FIG. 7 is a system block diagram of a sixth exemplary embodiment of a system according to the present invention.

### DETAILED DESCRIPTION OF EXEMPLARY EMBODIMENTS OF THE INVENTION

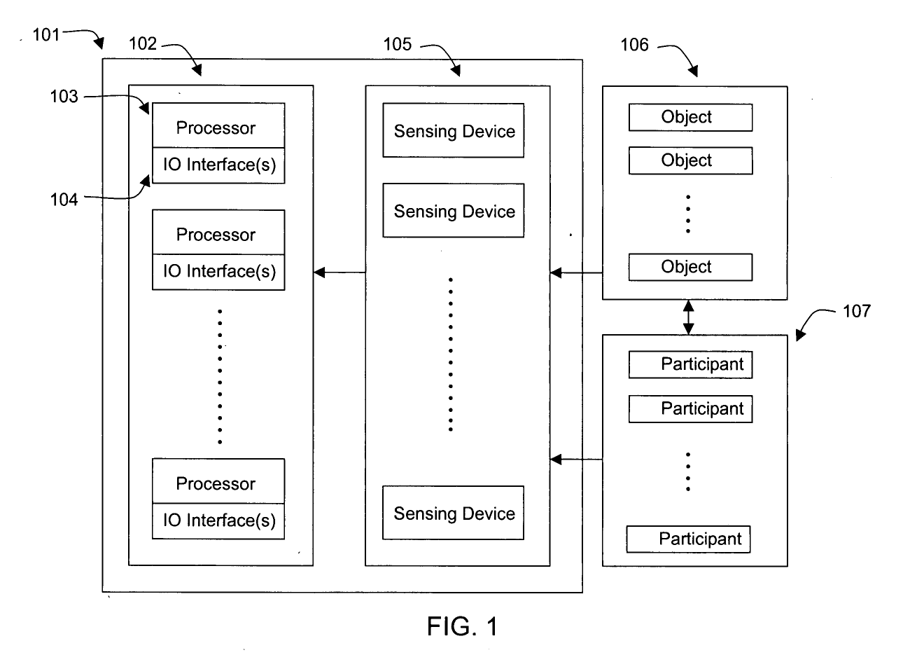

A first exemplary embodiment of a system 101 according to the present invention is shown in FIG. 1. The system 101 may comprise one or more sensing devices 105 and one or more processors 103. Each processor 103 may have associated therewith one or more input/output (“IO”) interfaces 104, each of which may comprise an input interface and/or an output interface. Each processor 103 may also be in communication with one or more storage devices.

One or more of the sensing devices 105 may be in data communication with at least one of the processors 103. Multiple sensing devices 105 may also be in communication with one processor 103. Multiple processors 103 may also be in communication with one sensing device 105. The sensing device 105 can comprise, for example, an optical sensor, a thermal sensor, a vibration sensor, an infrared sensor, an acoustic sensor, an ultraviolet sensor, or an electromagnetic radiation sensor. An optical sensor may comprise a video camera, e.g., a high speed camera.

Other input devices may also be associated with the exemplary system 101 shown in FIG. 1. Such input devices may include a mouse, a scanner, any of various pointing devices, a keyboard, or any other conventional input device.

One or more of the sensing devices 105 can be configured to obtain data relating to at least one object 106 and/or participant 107 by monitoring or detecting certain physical attributes associated with the object 106 or the participant 107. The data obtained by the sensing device 105 may include state data. The state data can include, but is not limited to, position data, or event data. The position data may comprise information relating to the position in space of an object or a range of positions in space, and/or other positional or locational information.

The object 106 may be a physical object that is capable of being freely moveable in space. For example, the object can be an inanimate object, and may comprise a ball, a balloon, a flying disc, a projectile, or any other object which may be freely movable in a medium, such as air or water. The movement of the object 106 can be influenced or controlled by physical forces applied to the object 106 including, but not limited to, being hit, bumped, thrown, tossed, blown, or shot. These forces may be provided directly or indirectly by one or more of the participants 107.

The event data, which may be referred to as the status data, may include, but is not limited to, an indication or a label that the object 106 is, for example, active, inactive, present, absent, within a defined physical boundary, outside of a defined physical boundary, intact, damaged, provided at a predefined goal location or position, provided away from a predefined goal location or position, requesting assistance, complete, incomplete, provided at or surpassing a predefined threshold in position or velocity, or any other such state or status.

The participants 107 may include animate objects such as, for example, a person, an animal, a biological organism, or another category of a living object. The participants 107 may be moveable in space, and/or can be located in a fixed position or location relative to a frame of reference. An example of the participants 107 located in a fixed position can be audience members seated in chairs.

The participants 107 and/or the objects 106 may interact with one another. For example, one object 106 may interact with one or more of the participants 107, simultaneously or at different times. In addition, one participant 107 may interact with one or more the objects 106, simultaneously or at different times. These interactions may be direct interactions or indirect interactions. For example, the direct interactions may include touching, pushing, bumping, colliding, or any other form of physical contact. The indirect interactions may include any other action which can cause a change in position, location or status of the objects 106 or the participants 107. Certain examples of the indirect actions may include, e.g., contacting the object 106 with a different object or implement, blowing air or shooting a stream of liquid against the object 106, firing or directing projectiles to contact the object 106, etc.

The sensing devices 105 may be in direct or indirect physical communication with the objects 106, the participants 107, and/or processors 103. For example, at least one sensing device 105 may not be in direct physical contact with at least one object 106 or participant 107. Certain sensing devices 105 may be in direct physical contact with one or more objects 106 or participants 107. Certain sensing devices 105 may relay information between other sensing devices 105 and/or other processors 103, and/or combinations thereof.

The state data may be provided to one or more of the processors 103. Such processors 103 may use the state data associated with certain sensed objects 106 and/or participants 107 to identify particular objects 106 and/or participants 107. This identification may be performed using conventional techniques that are known in the art. An indirect way of identification may be employed if certain objects 106 are not in a direct physical contact with other objects 106 and/or participants 107. For example, known optical tracking techniques may be used to follow the trajectory of the objects 106 and/or the participants 107 if the sensing device 105 is a video camera or another video sensor.

The sensor data may also be used to obtain the state data and/or the event data regarding the various objects 106 and/or participants 107. The determination or estimation of the state data and the event data may be achieved through analysis of the sensor data along with any other available referential data. This may be accomplished using any of various methods known to one of ordinary skill in the art. Part or all of the data so obtained may be provided to one or more requesting software or firmware applications (e.g., a game engine). The requesting application may identify time points at which to obtain the sensor data, specify refresh rates at which to update the state and event data, specify the objects 106 or the participants 107 that should be tracked or not tracked, and specify specific state events or specific state data or event data which should and/or should not be tracked. For example, the exemplary embodiment of the system, method, software arrangement and computer-accessible medium according to the present invention may be configured according to the specifications of one or more applications interfacing therewith.

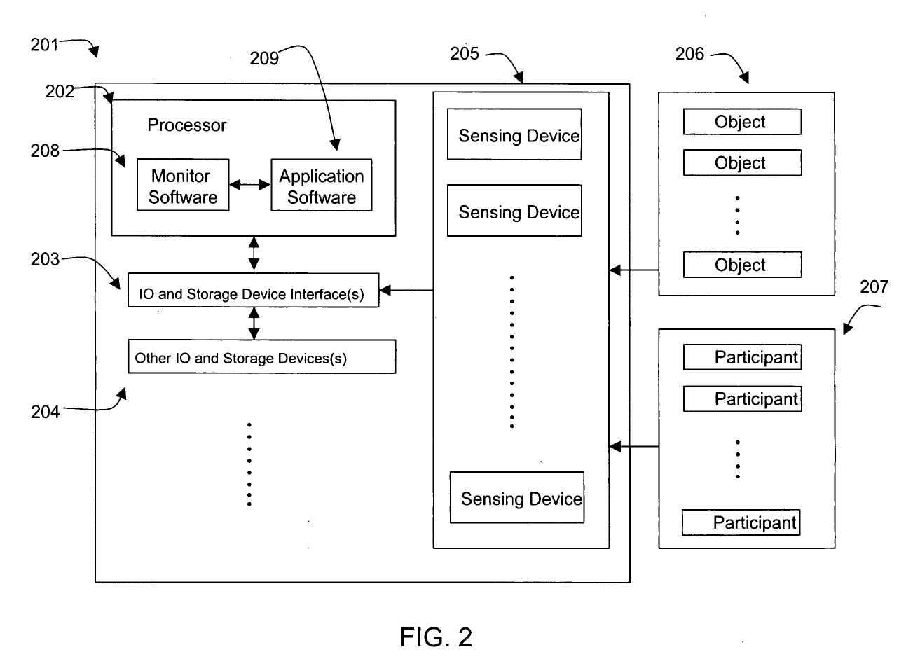

A second exemplary embodiment of a system 201 according to the present invention is shown in FIG. 2. Similarly to the exemplary system 101 in FIG. 1, the exemplary system 201 may comprise one or more processors 202. The processors 202 may have associated with them IO and storage device interfaces 203 which can be in communication with IO and storage devices 204. One or more sensing devices 205, which can obtain the sensor data from one or more objects 206 and/or one or more participants 207, may provide data to the processor 202 and/or the IO and storage device 204 via the interface 203. One or more of the processors 202 can be configured to execute instructions within at least one of two sets of modules. For example, the first module can comprise monitor software 208, and the second module can comprise application software 209.

The monitor software 208, for example, may configure the processor 202 to receive and relate various types of data including, but not limited to, the sensor data, identification of sensed objects and/or participants, the state information (for example, position and location information of the objects and/or participants), and/or the event data. The application software 209 may further configure the processor 202 to, e.g., define certain events which can be based at least in part on state information, determine which objects to monitor or to not monitor, which participants to track or not track, or which sensing times and refresh rates to use. The application software 209 may also configure the processor 202 to obtain or determine certain event data based at least in part on data provided by the execution using the monitor software 208, rather than this task being generated by the execution of the monitor software 208. In addition, the monitor software 208 may operate in a push mode or a pull mode. In the pull mode, the application software 209 can configure the processor 202 to make a request for the execution of the monitor software 208 to cause the processor 202 to perform in a manner similar to a conventional server. In the push mode, after the monitor software 208 has been initiated, it may periodically obtain data and pass it to the processor configured by the application software 209 until it receives a signal or command to stop. The application software 209 may configure the processor 202 to drive output devices 204 based on detected or calculated events. For example, the application software 209 can configure the processor 202 to provide an entertainment experience such as a game. When a game event takes place (e.g. a goal is scored), output devices 204 such as, e.g., a display or screen may be updated, and optionally sound and/or light may be produced to identify the event or consequences of the event to the participants 207 or other observers. In certain exemplary embodiments of the system according to the present invention, a first module comprising the monitor software 208 and a second module comprising the application software 209 may be combined within a single module.

The application software 209 may also configure the processor 202 to use data provided by the monitor software 208 to manipulate objects in a virtual environment. A plurality of virtual objects in a virtual environment may be generated by the processor 202 as configured by the application software 209. The motion or other characteristics of one or more such virtual objects may be affected at least in part by data provided by the monitor software 208. Such data may further comprise information received from the sensing device 205 via the interface 203, where such data may be related at least in part to the motion or other characteristics of one or more real objects 206 and/or one or more participants 207. Additionally, one or more output signals may be generated which relate to certain characteristics of virtual objects and/or real objects 206 and/or participants 207 or any combination thereof. The output signals may include a display showing images representing one or more virtual objects and/or real objects 206 and/or participants 207. The display may include, but is not limited to, a display screen, a projection display, a stereographic display, a volumetric display, a spatial light modulator, or a lightfield. The displayed images of the real objects 206 and/or the participants 207 may be obtained from various sensors such as, e.g., video cameras. The displayed images of virtual objects may be obtained from various sources including, but not limited to, one or more processors which can be configured to generate and animate the virtual objects or an external animation source.

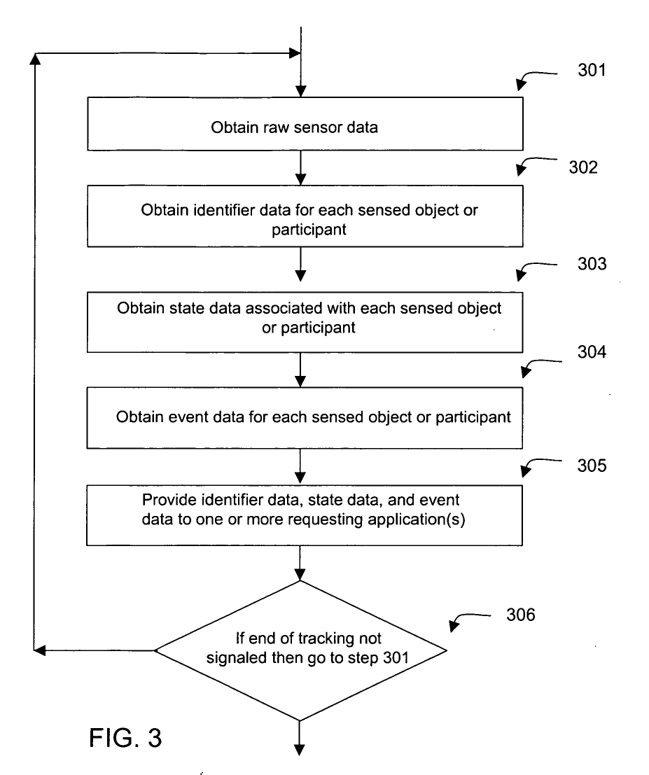

An exemplary embodiment of a method according to the present invention which can be used with various embodiments of the system is shown in FIG. 3. For example, the sensing device may be used to obtain raw sensor data (step 301) by monitoring or tracking certain attributes of one or more objects and/or participants. A processor may then be used to obtain identifier data for one or more of the sensed objects and/or participants (step 302). The raw sensor data and/or identifier data may then be used to obtain state data associated with one or more of the detected objects or participants (step 303). Event data may also be obtained for a detected object or participant (step 304). Such data may include whether a predetermined threshold has been met for a certain type of the state data associated with the object and/or the participant. The threshold may relate to the state data associated with a different object or participant, or to a predetermined position, velocity or the like. The processor may then provide the identifier data, the state data, and/or the event data to one or more requesting applications (step 305). Such data may then be used to direct, control or influence audio and/or video information, for example, to be used in generating a virtual environment and/or to control audio and/or visual effects in a physical environment. If a criterion for terminating the tracking and sensing routine has not been reached (step 306), then a new set of sensor data may be obtained (step 301) and the procedure repeated. If the criterion has been reached, then the procedure may be ended. This criterion may be based on, e.g., elapsed time, detection and/or calculation of predetermined event or state data, etc.

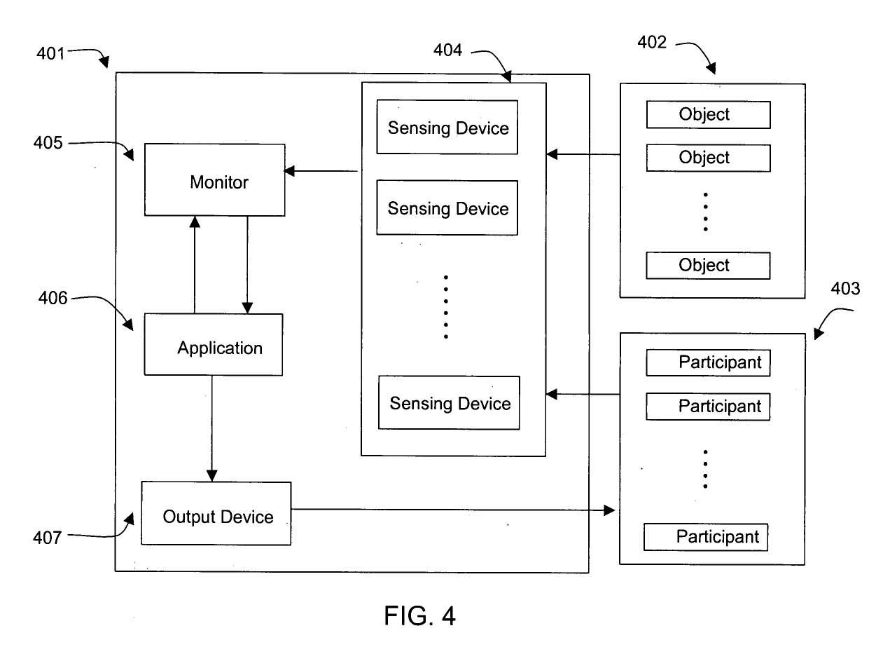

A third exemplary embodiment of a system 401 according to the present invention is shown in FIG. 4. Similar to the exemplary system 101 shown in FIG. 1, one or more objects 402 and/or one or more participants 403 may be sensed by one or more sensing devices 404 that are part of the exemplary system 401. A monitor module 405 can configure a processor to receive sensor data from the sensing devices 404. The monitoring module 405 may configure a processor to detect or otherwise obtain event data based at least in part on the sensor data and provide this to an application module 406. The application module 406 may configure a processor to provide requests, parameters, and/or control information to the monitor module 405. In certain exemplary embodiments of the system according to the present invention, the monitor module 405 may configure the processor to provide raw or partially processed sensor data to the application module 406, which can thereby configure a processor to obtain or generate event data that may be based at least in part on the sensor data. The application module 406 may configure the processor to send signals to one or more of the output devices 407 based at least in part on the sensor data and/or the event data. The output signals or output data of the output device 407 may be made available to the participant 403. This procedure may create information feedback, where the participant 403 may be provided with images, lights, sounds or any other form of information or data that may in certain ways affect or influence its interactions with the object 402, which in turn may be sensed by the sensing device 404. The data provided by the sensing device 404 may then be forwarded, at least in part, to the monitor 405, and thereby to the application 406. The application 406 may then configure a processor to send signals to the output device 407, and output signals or output data of the output device 407 again may be made available to the participant 403.

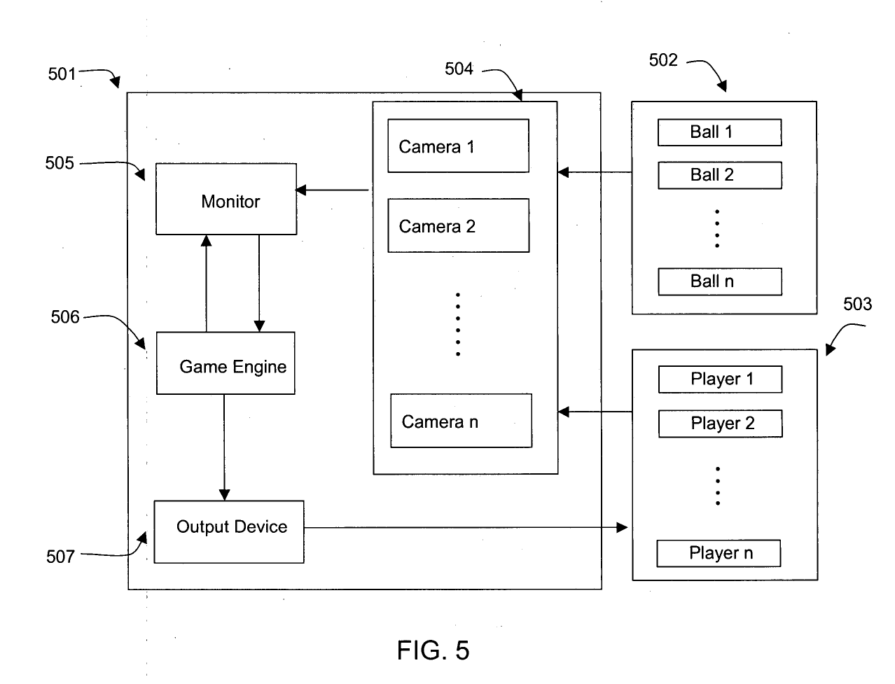

A fourth exemplary embodiment of a system 501 according to the present invention is shown in FIG. 5. In this exemplary embodiment, the objects may be one or more balls 502. The participants can be players 503 of a game. In certain exemplary embodiments of the present invention, the players 503 may be any of a variety of animate objects. The system 501 may comprise one or more cameras 504 that can function as sensing devices. The camera 504 may be a high-speed motion capture camera such as those that may be provided by Vicon Systems (including the camera model known as a Vicon Peak). A monitor 505 can receive data from the camera 504, and can perform various procedures, such as identification of the balls 502 and/or the players 503, obtaining and/or generating state and/or event data, and provide such data to a game engine 506. The game engine 506 may generate further event data, which may be based at least in part on the data received from the monitor 505 and/or on characteristics of one or more virtual objects. The virtual objects may be generated by the game engine 506, and may utilize parameters similar to the state data (described above) that can be used to describe physical objects such as the balls 502. Such parameters may include, e.g., position, velocity, size, location, color, and/or status of the virtual object. The virtual objects may include, but are not limited to, virtual players, virtual opponents, virtual team members, virtual goals, virtual obstacles, virtual boundaries, or any other virtual objects or things which may be depicted in a virtual environment. Some virtual objects may correspond to physical objects such as balls 502 or players 503, while others may not correspond to physical objects.

The game engine 506 may provide information to an output device 507, which can comprise a video display and/or other components such as one or more speakers or spotlights. The information provided by the game engine 506 may affect video displays, sound, lights, etc. that can be generated by the output device 507. The game engine 506 can include an application that receives sensor data and other state data from the monitor 505. The player 503 may react to the output device 507, which in turn may affect interactions with the one or more of the balls 502 or other physical objects in real-time. The game engine 506 can alternatively include a game interface that may be capable of managing interactions among the monitor 505, external game engine components, and the output device 507. The output device 507 may display information describing virtual objects and real world objects, where the information can be obtained, generated, and/or displayed as described above. For example, physical players 503 and/or physical balls 502 (or other physical objects) may interact, and information relating to these interactions can be combined with information describing or controlling at least in part the characteristics and/or behavior of one or more virtual objects (e.g., a virtual player, a virtual obstacle, or a virtual goal) which can be part of a game or entertainment experience. The information may be displayed using, e.g., a screen, a projector, an autstereoscopic display, a volumetric display, a spatial light modulator or a lightfield. Images corresponding to the physical players and/or physical objects (e.g., balls) or to other physical objects may be displayed together with images relating to a virtual environment, resulting in a combination of imagery derived from both physical and virtual environments.

In certain exemplary embodiments of the present invention, information related to the balls 502 (and/or other physical objects) and/or the players 503 may be obtained from more than one location or physical premises. For example, two or more separate locations may each have one or more balls 502 and/or players 503 (or, more generally, objects and/or participants), as well one or more cameras 504 (or other sensors) and, optionally, one ore more monitors 505 or other output devices. Communication may be established between two or more remote locations using various conventional communication methods such as, e.g., an internet connection or another type of network. In this manner, the players 503 who may be present at separate physical locations can engage in a coordinated entertainment experience or game. Game-related information may be communicated and/or processed using one or more processors which can be provided at one central location, where one or more remote sensors and/or remote output devices present at other locations may be configured to communicate with the processors. Alternatively, one or more processors may be provided at more than one physical location, and the processors may be configured to communicate using, e.g., peer to peer networking, master/slave networking, client-server architecture, etc. One or more balls 502 and/or players 503 may also be provided at one or more sets of contiguous or collocated physical premises such as, e.g., game zones, arenas, rooms, floors, wings, etc. The processors, sensors and displays may be configured to allow two or more such locations to play with or against each other. Multiple simultaneous multi-location games can also be provided, and these may be managed using various computing arrangements such as those described herein.

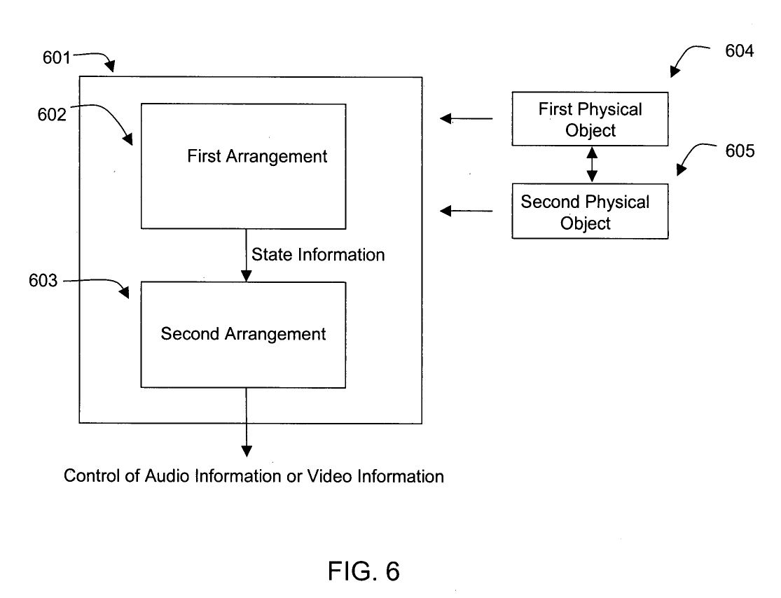

A fifth exemplary embodiment of a system 601 according to the present invention is shown in FIG. 6. One or more first physical objects 604 may interact with one or more second physical objects 605. The exemplary system 601 may comprise a first arrangement 602, which may further comprise one or more sensors. The sensors may be configured to detect and/or track characteristics of one or more of the first physical objects 604 and/or second physical objects 605. Such characteristics may include, but are not limited to, position, velocity, status, altitude, proximity, brightness, size, volume, or shape. The first arrangement 602 may be configured to provide state information relating to one or more of the first physical objects 604 and/or second physical objects 605 to a second arrangement 603. The second arrangement 603 can be configured to generate and/or manipulate one or more virtual objects in a virtual environment, where the characteristics of at least one such virtual object can be determined at least in part by the state information provided by the first arrangement 602.

The second arrangement 603 may also be configured to calculate, detect or determine interactions among the virtual objects. Such interactions may include momentum transfer, proximity, contact, attraction, repulsion, activation, deactivation, destruction, creation, and the like. One or more virtual objects may be identified with one or more of the first physical objects 604 or the second physical objects 605, where the characteristics of such a virtual object may be correlated with the characteristics of the physical object 605 it is identified with. One or more virtual objects may not be identified with any of the physical objects, and their characteristics may only be affected by interactions with other virtual objects, some of which may be identified with the physical objects 605. The second arrangement 603 may generate signals to control audio and/or video information based on the characteristics of one or more virtual objects. The video information may be in the form of images on a display and/or characteristics of one or more lights such as on/off, color, intensity, or projected direction. The audio information may be in the form of various sounds or noises that can be generated by one or more speakers or other sound-producing devices.

### EXAMPLE

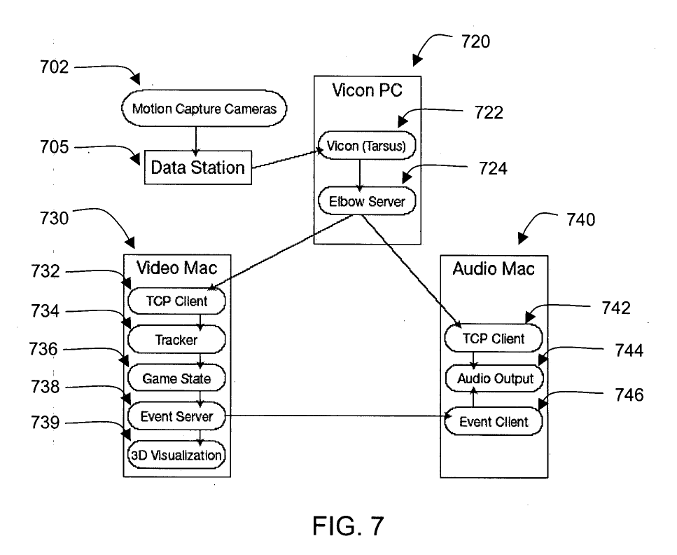

The system, method, software arrangement and computer-accessible medium according to the present invention may provide an entertainment experience based on a large-scale motion capture system. One exemplary embodiment of the present invention comprises a game referred to herein as “Squidball.” Such squidball can be played by a group of people in an auditorium or similar location, using one or more large reflective balls and a video display screen. The balls may be, e.g., weather balloons that can be covered with a reflective material to improve tracking of their motion and position by video cameras. The balls may also be filled at least in part with helium to provide buoyancy. Squidball can be implemented using an exemplary embodiment of a system 701 according to the present invention comprising three components shown in FIG. 7: e.g., a Vicon PC 720, a video Mac system 730, and an audio Mac system 740. The video system 730 and audio system 740 can be configured to run on a single computer or on two or more separate computers. Components of this exemplary system 701 in accordance with the present invention are described below in further detail.

For example, a data station 705 can be configured to receive positional data of the reflective balls from a plurality of the motion capture cameras 702. A plurality of motion capture cameras 702 may be placed and calibrated to detect the location of the reflective balls within the auditorium or other physical space where the game is being played. The Vicon PC 720 can be configured to collect raw image data from the data station 705, process the data, and provide data reconstruction results through a real-time software package 722 (labeled, e.g., Tarsus), which may be obtained from Vicon.

An elbow server 724 can be provided which can be associated with the Vicon PC 720. The elbow server 724 may use TCP/IP sockets to communicate with the Vicon PC 720 configured by the Tarsus software package 722, and to transmit data to the video TCP client 732 and to the audio TCP client 742.

The elbow server can be a data replication component capable of receiving motion capture data from the Tarsus software package 722 and echoing that data to a plurality of client systems. Exemplary clients include the video TCP client 732 and the audio TCP client 742.

The video TCP client 732 can act as the “master” in the system, setting the overall frame-rate of the game. At the start of each frame, the master video client 732 may transmit a request to the elbow server 724 for a current frame's motion capture data. The elbow server 724 can then relay this request to the Vicon Tarsus software package 722, which can then respond with a list of {x, y, z} points representing the current position for all recognized balls. The elbow server 724 may then transmit this data back to the master video client 732. All other clients (including the audio TCP client 742) that request the current motion capture data from the elbow server 724 at any time can receive a copy of the last data sent to the master video client 732. In this manner, the master video TCP client 732 can establish the frame-rate for the overall system and the other components in the system may be synchronized to the video system 730.

The video TCP client 732 can be configured to receive a list of {x,y,z} points from the elbow server 724. These points may represent the spatial positions of tracked objects, such as the reflective balls. The points, which may be established using the Vicon Tarsus software package 722, can be unlabeled and/or unordered, and thus they may be uncorrelated to specific physical balls. However, such identifiers or labels may be preferable to assist in determining, for example, how fast each specific ball may be moving and may be used, e.g., to show trails behind balls and/or to generate sounds associated with the motion. To provide this identification or labeling of the points, the video Mac system 730 may further comprise a tracker 734.

The tracker 734 may be configured to perform motion analysis on the raw data provided by the Vicon Tarsus software package 722, and to label the points obtained fby detection of tracked objects. The tracker 734 may receive as input data a list of {x, y, z} points from the Vicon PC 720. This tracker 734 may then generate as output a list of labeled points, together with the velocity of each point, i.e.:
Tracker(x,y,z)→{(x, y, z), (vx, vy, vz), label},
where Tracker operates on spatial coordinates (x,y,z), (vx, vy, vz) can be a vector specifying the velocity components of the ball, and. label may be an integer providing an identifier for each physical ball that may be tracked.

The tracker 734 may be implemented in Java programming language and can, for example, use data from the previous 2 frames together with a Kalman filter to label balls and estimate ball velocity in a robust way that takes noise into account. The noise covariance matrix (a standard component of the Kalman filter) may be estimated from lab recordings. The Tracker can pass the annotated list of points on to a game state module 736, which may be implemented in Java and Max/Jitter, and which can process the game simulation.

The exemplary embodiment of the game system 701 shown in FIG. 7 may contain software modules, hardware and/or firmware to control various aspects of the game. The game state module 736 can be configured to generate a virtual environment that may comprise a representation of the detected position of one or more physical balls in terms of their (x,y,z) coordinates and one or more virtual markers or goals that may be generated and specified using the same (x,y,z) coordinate system used to represent the position and velocity of the physical balls. The game state module 736 can also be configured to record such parameters as, e.g., a current game level, one or more scores, the position of detected balls, virtual markers and/or goals, and/or time remaining in the present game level or in the game itself.

The exemplary embodiment of the game system 701 may further comprise an event server 738 that may be used to detect, e.g., collisions between the virtual representations of the physical balls and the virtual game markers in the common coordinate system used to represent them, and/or to advance game state parameters in response to such collisions, goals scored, and/or elapsed time on a game clock. The event server 738 can be configured to monitor the game state and generate high-level game events that can be broadcast to the audio Mac system 740 via the event client 746. Events may include, but are not limited to, collision events (e.g., between physical balls, between virtual representations of physical balls and virtual targets or goals, between physical balls and a floor or wall, and the like), predetermined point-scoring criteria such as, e.g., a collision between the virtual representation of a physical ball and a virtual marker or goal, events that are predetermined to occur at the start and/or end of a game level, etc.

A three-dimensional (3D) visualization module 739 comprising a 3D graphics engine may also be provided that is capable of rendering the current game state via, e.g., OpenGL commands. The 3D engine may support various visual effects such as, for example, adding trails to balls, generating explosions when virtual markers are contacted by the virtual representation of physical balls, and/or changing the spatial coordinates of a virtual 3D camera that can be used to generate images of the virtual environment. These characteristics of the virtual environment may be converted to video data capable of being shown on a display device by the 3D visualization module 739. The 3D visualization module 739 may further comprise a resource loader capable of loading graphic files (e.g., pictures, textures, or videos) that can be associated with virtual objects and the virtual environment.

The exemplary system 701 may further utilize a show control that can manage the overall game system, including performing such functions as resetting the game, starting and stopping communication and rendering routines, advancing the game state to the next level, and the like. The show control may also comprise a difficulty adjustment function, which can increase or decrease the effective size of one or more virtual targets or goals. In this manner, the collisions can be with virtual representations of the physical balls either easier or more difficult to achieve. The difficulty may be adjusted based on, e.g., the game time elapsed, the game level being played, the current score, or other game-related parameters.

The exemplary audio Mac system 740 may be resident as a Max patch on a second computer or optionally on the same computer as the video Mac system 730. The audio system 740 can be configured to receive both the low-level motion capture data, and higher-level event data generated by the game engine. The audio Mac system 740 may comprise a synthesizer/sampler implemented in Max/MSP that can generate, e.g., quadraphonic sounds, via an audio output 744. Signal-processing parameters generated by the audio Mac system 740 may be modulated, for example, by collisions between physical balls, collisions between virtual representations of physical balls and virtual objects, floor bounces, as well as by position, acceleration, and/or velocity of the physical balls, and/or by other state data and/or events related to the physical and/or virtual objects.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. In addition, all publications or other documents referenced herein are incorporated herein by reference in their entireties. An appendix providing a listing of an exemplary software code that is capable of being used with certain exemplary embodiments of the present invention is attached herewith, and is also incorporated by reference in its entirety.

What is claimed is:

1. A system comprising:
at least one first arrangement configured to obtain state information associated with at least one first physical object when the at least one first physical object is not in contact with at least one second physical object, wherein the at least one first physical object is capable of moving independently of the at least one second physical object, and wherein the at least one second object is capable of affecting at least one state of the at least one first physical object; and
at least one second arrangement configured to control at least one of audio information and video information in a virtual environment as a function of the state information.

2. The system of claim 1, wherein the first arrangement comprises a sensing device.

3. The system of claim 2, wherein the sensing device is provided separate from the at least one first physical object.

4. The system of claim 2, wherein the sensing device comprises at least one of an optical sensor or a video camera.

5. The system of claim 1, wherein the at least one first physical object is at least one of a balloon, a ball, or a flying disc.

6. The system of claim 1, wherein the at least one first physical object comprises a plurality of physical objects.

7. The system of claim 1, wherein the at least one second physical object is an anatomical object.

8. The system of claim 1, wherein the at least one first physical object is at least one of a balloon, a ball, or a flying disc.

9. The system of claim 1, wherein the at least one state comprises at least one of position, velocity, altitude, acceleration, color, brightness, or loudness.

10. The system of claim 1, wherein the at least one state comprises at least one of an active state, an inactive state, a present state, an absent state, an intact state, a damaged state, being at a goal position, being away from a goal position, requesting assistance, a complete state, an incomplete state, or being at a predetermined position relative to at least one of a third physical object, a defined boundary, or a defined location.

11. The system of claim 1, wherein the at least one second arrangement comprises a processor.

12. The system of claim 1, wherein the at least one first arrangement and the at least one second arrangement are situated within a common housing.

13. The system of claim 1, wherein the at least one first arrangement is configured to obtain state information in real time.

14. The system of claim 1, wherein the video information comprises the location of at least one first virtual object.

15. The system of claim 1, wherein the at least one second arrangement is further configured to detect an interaction between the at least one first virtual object and at least one second virtual object.

16. The system of claim 1, wherein the at least one second arrangement is further configured to control characteristics of one or more physical lights as a function of the state information, wherein the characteristics include at least one of color, intensity, direction, or on/off state.

17. A method for providing an entertainment system comprising:
obtaining state information associated with at least one first physical object when the at least one first physical object is not in contact with at least one second physical object, wherein the at least one first physical object is capable of moving independently of the at least one second physical object, and wherein the at least one second object is capable of affecting at least one state of the at least one first physical object; and
controlling at least one of audio information and video information in a virtual environment as a function of the state information.

18. A software arrangement comprising:
a first software module which, when executed by a processing arrangement, configures the processing arrangement to receive state information associated with at least one first physical object when the at least one first physical object is not in contact with at least one second physical object, wherein the at least one first physical object is capable of moving independently of the at least one second physical object, and wherein the at least one second object is capable of affecting at least one state of the at least one first physical object; and
a second software module which, when executed by the processing arrangement, configures the processing arrangement to control at least one of audio information and video information in a virtual environment as a function of the state information.

19. A computer-readable medium comprising:
a first set of executable instructions which, when executed by a processing arrangement, configure the processing arrangement to receive state information associated with at least one first physical object when the at least one first physical object is not in contact with at least one second physical object, wherein the at least one first physical object is capable of moving independently of the at least one second physical object, and wherein the at least one second object is capable of affecting at least one state of the at least one first physical object; and
a second set of executable instructions which, when executed by the processing arrangement, configure the processing arrangement to control at least one of audio information and video information in a virtual environment as a function of the state information.
